(19) United States
(12) Patent Application Publication
(10) Pub. No.: US 2008/0237020 A1
(43) Pub. Date: Oct. 2, 2008

(54) Switch device having a spacer organizing contact tails

(75) Inventors: Lie-Yi Hu, ShenZhen (CN); Yong-Hui Hu, ShenZhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/077,151

(22) Filed: Mar. 17, 2008

(30) Foreign Application Priority Data
Mar. 16, 2007 (CN) 200720035418.1

(51) Int. Cl. H01H 1/10

(52) U.S. Cl. 200/516

(57) ABSTRACT

A casing, in which a plurality of contacts are fixed, an operation element which is arranged so as to be able to move in translation in the casing, a conductive dome-like member which is arranged in the casing and which is resiliently deformable under the action of the displacement of the operation element between a first state and a second state of commutation, the light source is fixedly joined to the casing, the switch device further defines a spacer which connected the casing for fixing the tail of the contacts so as to prevent the contacts from distorting.

### 1. FIELD OF THE INVENTION

The present invention relates to a switch device, And more particularly, to a switch device having a spacer attached onto the casing to properly organize contact tails thereof.

### 2. DESCRIPTIONS OF RELATED ARTS

U.S. Pat. No. 7,235,754 issued to Rochon on Jun. 26, 2007 discloses a switch device of the type comprising: a casing, in which a plurality of conductive tracks are fixed, an operation element which is arranged so as to be able to move in translation in the casing, a conductive dome-like member which is arranged in the casing and which is resiliently deformable under the action of the displacement of the operation element between a first state and a second state of commutation, a light source and at least two power supply tracks for the light source. The light source is fixedly joined to the operation element, the operation element being provided with at least two contact elements which connect, over the entire axial travel of the operation element in the casing, the light source to the respective power supply tracks.

In such devices, which are in particular used in producing keypad type switches of electrical devices, a translucent button, which is fixedly joined to the operation element, covers the light source. The device is activated by a user pressing on the translucent button in such a manner that the position of the translucent button with respect to the light source varies in accordance with the commutation state of the switch device.

In order to have the terminals soldered onto the PCB, tails of the terminals may be designed to be long sufficient to lead to the PCB to achieve its soldering process. The longer tails of the terminals, however, are apt to be distorted during transportation and/or repeated handling of such a connector with the long terminal tails exposed. The distorted tails of the terminals will lose its true position, which affects the effective electrical connection to the PCB.

An aspect of the invention is to provide a connector with a spacer, which allows the tails to be arranged in true position.

### SUMMARY OF THE INVENTION

To this end, in a switch device according to the invention, the light source is fixedly joined to the casting, a spacer attached to the insulating housing being provided with the switch device for fixing the terminals and the tail of contacts so as to prevent its from distorting.

According to specific embodiments of the invention, the switch device comprises one or more of the following features: a casing, in which a plurality of contacts are fixed, the contacts exposed of the casing, a light source and at least two power supply tracks for the light source, an operation element which is arranged so as to be able to move in translation in the casing along an activation axis Z, a conductive dome-like member which is arranged in the casing and which is resiliently deformable, under the action of the displacement of the operation element, and a spacer, which attached onto the casing, the spacer defining fixture holes for receipt of the respective contacts.

The invention will be better understood from a reading of the description below which is given purely by way of example and with reference to the drawings.

The novel features of the invention are set forth with particularity in the appended claims. The invention will be best understood from the following description when read in conjunction with the accompanying drawings.

### BRIEF DESCRIPTION OF THE DRAWINGS

FIG. 1 is an exploded perspective view of a switch device according to a preferred embodiment of the present invention;

FIG. 2 is a perspective view of a spacer of FIG. 1;

FIG. 3 is a perspective view of a casting of FIG. 1;

FIG. 4 is an assembled view of the switch device of FIG. 1, and

FIG. 5 is a sketch view showing a relationship of the fixture holes of the spacer and a contacts of FIG. 4.

### DETAILED DESCRIPTION OF THE PREFERRED EMBODIMENT

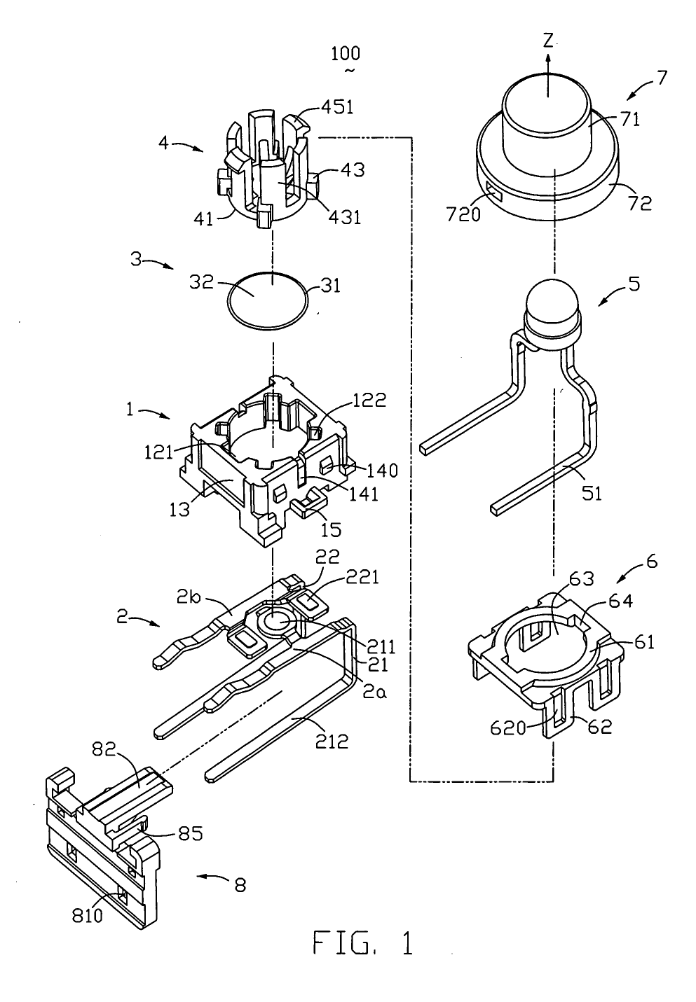

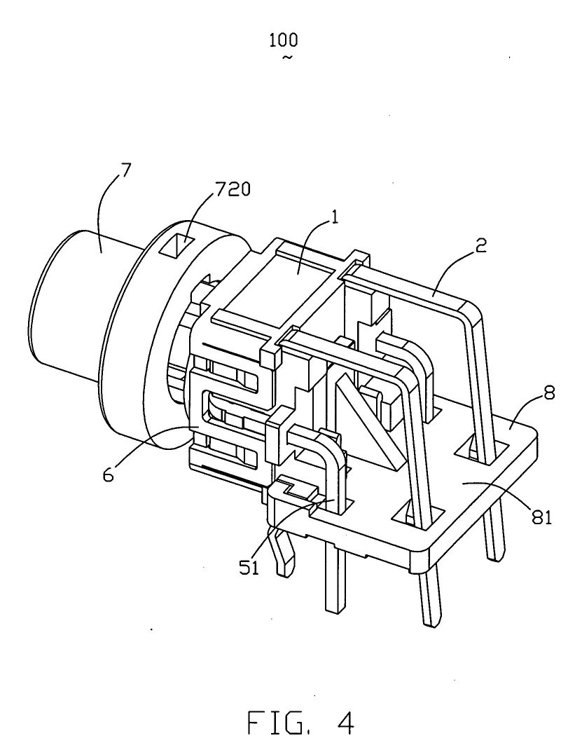

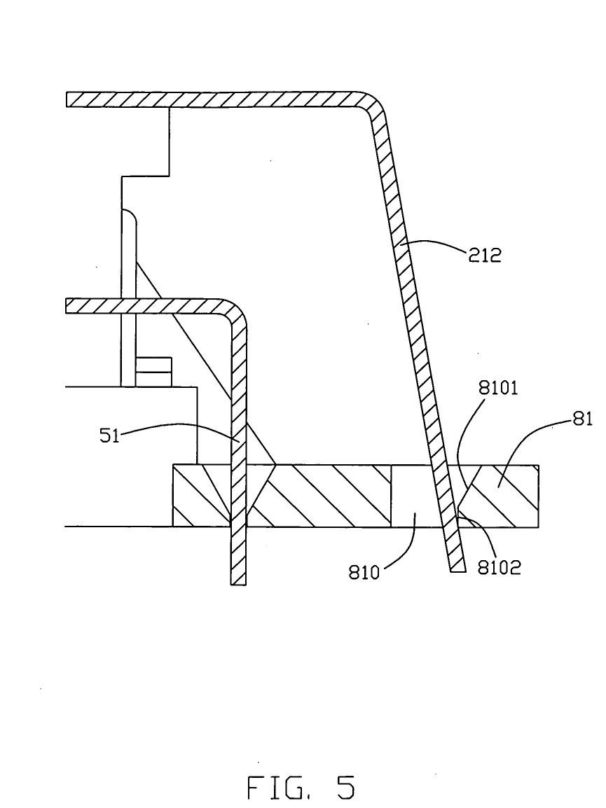

The switch device 100 illustrated in FIGS. 1 to 5 comprises a casing 1, an operation element 4, which is movable relative to the casing; a spacer 8 attached to the casing 1, and a conductive dome-like member 3, which is accommodated in the casing 1.

In the entirety of the description, it will be assumed that the switch device 100 is orientated in such a manner that the operation element 4 is movable in translation relative to the casing 1 along vertical axis Z-Z.

In this orientation, the casing 1 has a bottom wall 10. The conductive dome-like member 3 is arranged in the casing 1 between the bottom wall 10 and the operation element 4. The casing 1 internally delimits a housing 11 of generally cylindrical form that is closed at the lower end thereof by the bottom wall 10, the casing 1 is produced from insulating plastics material, A conductive region extends in a central region of the bottom wall 10 of the casing 1, the central pad 211 and the border pad 221 are aligned with the surface of the bottom 9 of the casing.

The generally cylindrical lateral surface of the housing 11 is interrupted by four channels 122 which are angularly offset by 90 degree about axis Z. These channels 122 extend axially along generating lines of the cylindrical wall. The lateral surface of the housing 11 is further interrupted by two diametrically opposed grooves 121 generally rectangular cross-section which extend along axis Z.

The casing 1 further comprises a pair of terminals 51 and the tail of contacts 2, in this case six in number, which project in three rows of two from the same lateral face of the casing. In the embodiment illustrated these terminals 51 and the tail of contacts 2 which are intended to connect a printed circuit board, in particular by welding. However, the terminals 51 and the tail of contacts 2 are too long to firmness.

The central pad 211 of the conductive regions 30 at the bottom of the channel 122 and the border portion 31 of dome 3 electrically connected to the border pads 221.

At the lateral face of the casing 1, from which the terminals 51 project, two pins 212 for mounting and positioning the casing on a printed circuit board are formed. Furthermore, lugs 140 for attaching the strap 6 are formed at two other lateral faces of the casing 1.

The conductive dome-like member 3 having a central portion 32 of generally disc-like form, and the border portion 31 which project radially downwards from the central portion. The border portion 31 contacts with the border pads 221 of the conductive regions 30, the dome-like member 3 is preferably produced from steel in order to confer on it good performance in terms of mechanical strength and resilience, and is preferably further coated by gold plating so as to improve the electrical conductivity thereof.

In this manner, when the central portion 32 of the dome-like member is depressed until it comes into contact with the central pad 211, the border portion 31, which comes into contact the border pads 221.

Whatever the state of the switch device 100, the block of the operation element 4 is supported on the central portion 32 of the dome-like member 3. The dome-like member 3 rests at the bottom of the casing 1, by the border portion 31 being in contact with the border pad 221 at the bottom 10 of the casing. The contact of the border pad 22 is permanent, whatever the state of the switch device, the central portion 32 is not in contact with the central pad 211.

The operation element 4 comprises a cylindrical ring 45 which is closed at the lower base thereof by a circular plate 41 forming a bottom, and which is fixedly joined, at the periphery thereof, to four radially projecting blocks 43 which are angularly offset by 90 degree relative to each other about axis Z. These blocks 43 are engaged and can slide axially in the channels 122 in order to prevent any significant rotation of the operation element 4 with respect to the casing 1 about axis Z, whatever the axial position thereof. The ring 45, the bottom 41 and the blocks 43 are preferably produced in one piece from plastics material. The ring 45 defines a plurality of slots 431 which are extended the bottom 41.

The two terminals 51 of the LED is inserted and fixed, respectively. The LED 5 to be precisely secured and positioned on the casing 1.

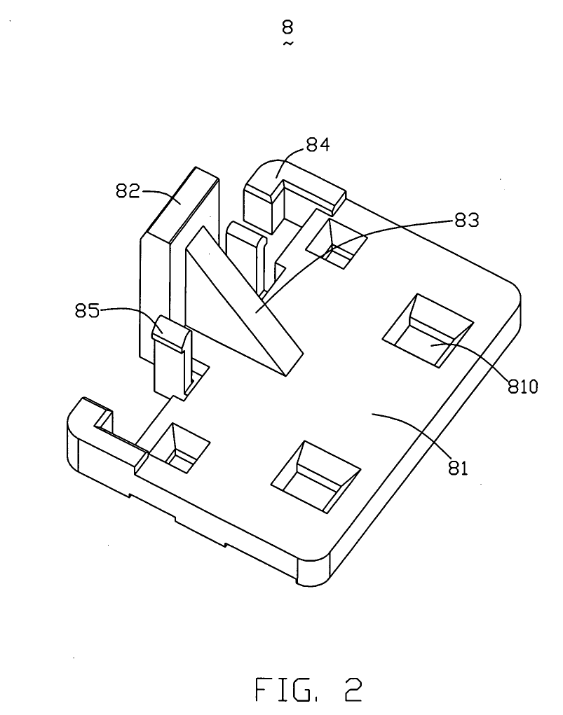

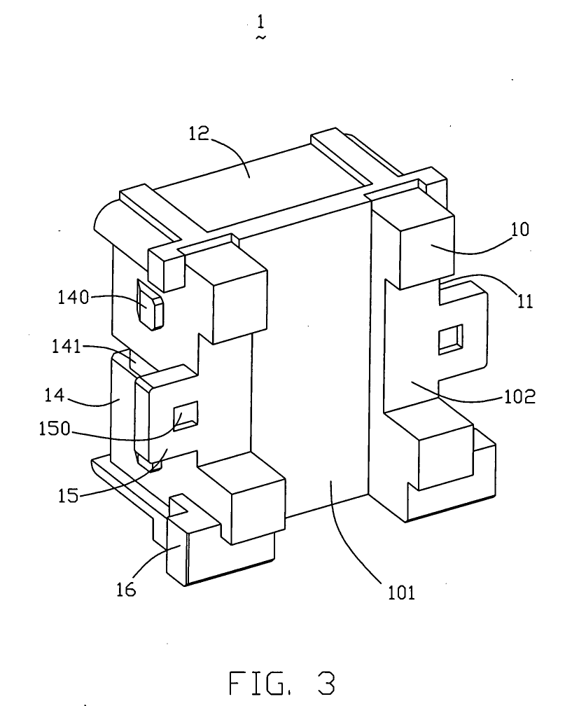

It will be appreciated that the upper surface of the ring 45 is raised relative to the blocks 43, which allows the ring 45 to project from the casing 1, as is visible in FIGS. 2 and 3, in the rest position of the device, whilst the blocks 43 are engaged in the respective channels 122.

The switch device 100 further comprises a strap 6 for retaining the conductive dome-like member 3 and the operation element 4 in the casing 1, a light source 5 that is constituted, in the embodiment illustrated, by a light-emitting diode (LED), and a transparent or translucent push-button 7. This button 7 is separate from the operation element 4, above the light-emitting diode 5.

The strap 6 is formed by a planar plate 61 of generally square form, the outer edges of which substantially coincide with those of the upper surface of the casing 1, and is provided with lateral tabs 62 which are folded down perpendicularly. Each of these lateral tabs 62 is hollowed out so as to be able to engage over one of the lugs 140. In this manner, the strap 6 can be resiliently engaged, along axis Z, on the casing 1 by the attachment means, which are constituted by the lugs 140, on the one hand, and complementary lateral tabs 62, on the other hand. The planar plate 61 is formed with a central through-hole 63 of circular form and having dimensions corresponding to the outside diameter of the ring 45.

The button 7 is of a generally hollow-cylindrical form that can receive internally an upper portion of the LED 5, and is provided at the base thereof with a collar 72, from which two downwardly opposing recesses 720 are formed. These recesses 720 allow the button 14 to be fixed to the operation element 4 by means of cooperation with tab 451 of a peripheral shoulder of the ring 45. The collar 72 is then supported on the upper surface of the ring 45.

The strap 6 is engaged on the casing 1 and the planar plate 61 constitutes an axial stop for the blocks 43 and, in this manner, prevents the operation element 4 from being withdrawn from the casing 1, similarly to the dome-like member 3.

The operation element 4 clearly projects upwards from the casing 1 and the LED 5 itself projects upwards from the ring 45 of the operation element 4. The LED 5 is covered by the button 7, which is resiliently engaged on the ring 45 by means of the recesses 720 coupled with tab 451.

The behavior of the switch device when the operation element 4 is activated will now be described. The device has not been illustrated in the activation state thereof, corresponding to the resilient deformation of the switch mechanism 100, and in particular the dome-like member 3.

As has been seen above, the operation element 4 can be activated by means of pressure on the button 7 that is fixedly joined thereto.

The spacer 8 which attached onto the casing 1; the spacer defining fixture holes 810 for receipt of the respective contacts 212, 51. The fixture hole 810 defines thereof an inner sidewall, said inner sidewall including a first sloped wall surface 8101 spaced from the corresponding contact with a distance, and a second wall surface 8102 abutting against said contact. The fixture hole 810, along an insertion direction that said contact is inserted thereinto, in turn includes a top hole segment in width being larger than that of said contact, and a bottom hole segment in width being substantially equal to that of said contact.

The spacer 8 includes a level portion 81 and baffle 82 that project upwards from a lateral side of the level portion, the bottom wall of the casing defines a groove 101 received the baffle of the spacer. The level portion 81 defines a pair of small holes 811 and a pair of holes 810, the terminals 51 through the hollow portion 150 of the casting 1, and then received in the small holes 811. The tail of contacts 2 extends from the casting 1, and forms a first angle with respect to a vertical line. The tail of contacts 2 received in the holes 810 respectively. The first sloped wall surface forms a second angle relative to the vertical line.

When the operation element 4 is depressed in the casing 1 in this manner, over a first axial travel, the dome-like member 3 is abruptly deformed in flexion so that the central portion 32 is urged towards the bottom 10 of the casing.

This first phase, which corresponds to the first axial travel of the operation element 4, is effected in this manner until the central portion 32 of the dome-like member comes into contact with the central pad 211.

It is also apparent that, over the entire travel of the operation element 4, the relative position of the light source 5 is maintained in an unchanged state.

When the pressure on the operation element 4 is released, it will be appreciated that the dome-like member 3 again takes up, and the dome-like member 3 in succession, the initial rest form thereof, with the blocks 43 being repelled and stopped on the lower face of the plate 61.

The switch device then moves back into its first state of commutation, in which the dome-like member 3, and therefore the central portion 32 is insulated from the central pad 211, the border pad 221 being electrically connected to each other by means of the dome-like member 3.

The novel features of the invention are set forth with particularity in the appended claims. The invention will be best understood from the following description when read in conjunction with the accompanying drawings.

1. A switch device comprising:
a casing, in which a plurality of contacts is fixed, the contacts exposed of the casing;
an operation element which is arranged so as to be able to move in translation in the casing along an activation axis Z;
a conductive dome-like member which is arranged in the casing and which is resiliently deformable, under the action of the displacement of the operation element; and
a spacer attached onto the casing, the spacer defining fixture holes for receipt of the respective contacts.

2. The switch device of claim 1, wherein each fixture hole defines thereof an inner sidewall, said inner sidewall including a first sloped wall surface spaced from the corresponding contact with a distance, and a second wall surface abutting against said contact.

3. The switch device of claim 1, wherein the fixture hole, along an insertion direction that said contact is inserted thereinto, in turn includes a top hole segment in width being larger than that of said contact, and a bottom hole segment in width being substantially equal to that of said contact.

4. The switch device of claim 1, wherein the spacer includes a level portion and a baffle that projects upwardly from a lateral side of the level portion, the casing having the bottom wall defining a groove for receiving the baffle of the spacer.

5. A connector comprising:
a casing, in which a plurality of contacts exposed out of a back wall of the casing;
the contact having a tail portion spaced away from said back wall; and
a spacer, the spacer defining fixture slots for receipt of the tail portion, the fixture slot defining thereof an inner sidewall, said inner sidewall including a first sloped wall surface spaced from the contact with a distance, and a second wall surface abutting against said contact.

6. The switch device of claim 5, wherein said tail portion forms a first angle with respect to a vertical line, and the first sloped wall surface forms a second angle relative to the vertical line.

7. The switch device of claim 6, wherein said tail portion and the first sloped wall surface are disposed on opposed relationship with respect to the vertical line.

8. The switch device of claim 7, wherein the second angle is greater than the first angle.

9. The switch device of claim 5, wherein the spacer includes a level portion, and a baffle that project upwardly from a lateral side of the level portion, the casing defines a groove on the bottom wall thereof, the groove adapted for receiving the baffle of the spacer.

10. An electrical switch comprising:
a casing holding a pair of terminals and a light therein, said light including a pair of legs;
a pressing member covering the light in a pressing direction and activating a flexible dome to selectively contact the terminals; and
a spacer attached to the casing and holding both tails of said terminals and said legs; wherein
said light is immoveable.

11. The switch as claimed in claim 10, wherein the legs extend obliquely through the spacer while the tails of the terminals extend vertically through the spacer in front of the legs.

12. The switch device of claim 2, wherein the fixture hole, along an insertion direction that said contact is inserted thereinto, in turn includes a top hole segment in width being larger than that of said contact, and a bottom hole segment in width being substantially equal to that of said contact.
